(19) United States
(12) Patent Application Publication
(10) Pub. No.: US 2021/0003979 A1
(43) Pub. Date: Jan. 7, 2021

(54) MOBILE PLATFORM SYSTEM AND MOBILE PLATFORM PAYLOAD SYSTEM

(71) Applicant: SZ DJI TECHNOLOGY CO., LTD., Shenzhen (CN)

(72) Inventors: Yucheng LIU, Shenzhen (CN); Qi ZHOU, Shenzhen (CN); Shijing GAO, Shenzhen (CN); Peng DING, Shenzhen (CN); Xiangyu CHEN, Shenzhen (CN)

(21) Appl. No.: 17/024,379

(22) Filed: Sep. 17, 2020

Related U.S. Application Data
(63) Continuation of application No. PCT/CN2018/080686, filed on Mar. 27, 2018.

(51) Int. Cl. G05B 19/042; H04W 28/06; H04W 28/02

(52) U.S. Cl. CPC G05B 19/042; H04W 28/06; G05B 2219/2651; G05B 2219/25252; H04W 28/0284

(57) ABSTRACT

The present disclosure provides a mobile platform system. The system includes a mobile platform; a payload controller connected to the mobile platform through a first communication link for generating a payload control signal; a payload connected to the payload controller and configured to receive the payload control signal generated by the payload controller; and a gimbal carried by the mobile platform, the gimbal including a gimbal controller and a gimbal driver, the gimbal controller being communicatively connected to the payload controller through a second communication link to control the gimbal driver.

### CROSS-REFERENCE TO RELATED APPLICATION

This application is a continuation of International Application No. PCT/CN2018/080686, filed on Mar. 27, 2018, the entire content of which is incorporated herein by reference.

### TECHNICAL FIELD

The present disclosure relates to the field of mobile systems and, more specifically, to a mobile platform system, and a mobile platform system carrying a payload.

### BACKGROUND

Mobile platforms, such as unmanned aerial vehicles (UAVs), robots, mobile vehicles, mobile boats, or underwater mobile devices, play an important role in many fields, such as filming and television, search and rescue, police work, military services, etc. These mobile platforms can adapt to complex environments. A mobile platform can carry payloads, such as imaging devices and detection equipment, to accomplish various tasks, such as imaging and detection tasks.

### SUMMARY

One aspect of the present disclosure provides a mobile platform system. The system includes a mobile platform; a payload controller connected to the mobile platform through a first communication link for generating a payload control signal; a payload connected to the payload controller and configured to receive the payload control signal generated by the payload controller; and a gimbal carried by the mobile platform, the gimbal including a gimbal controller and a gimbal driver, the gimbal controller being communicatively connected to the payload controller through a second communication link to control the gimbal driver.

Another aspect of the present disclosure provides a mobile platform payload system. The system includes a payload; a payload controller connected to the payload for controlling the payload; and a gimbal including a gimbal controller and a gimbal driver, the gimbal controller being communicatively connected to the payload controller for controlling the gimbal driver.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a block diagram of a mobile platform system according to an embodiment of the present disclosure.

FIG. 2 is a schematic diagram of the mobile platform system shown in FIG. 1.

### DETAILED DESCRIPTION OF THE EMBODIMENTS

The technical solutions of the embodiments of the present disclosure will be described in detail with reference to the accompanying drawings of the embodiments of the preset disclosure. The embodiments described herein are only some embodiments of the present disclosure, and are not all of the embodiments. All other embodiments obtained by a person having ordinary skills in the art based on these embodiments of the present disclosure without spending creative effort all belong to the scope of protection of the present disclosure.

The illustrative embodiments will be described in detail, examples of which are shown in the accompanying drawings. In the following descriptions, when the accompanying drawings are referenced to, unless there are other express indication, the same numbers in different accompanying drawings indicate the same or similar elements. The implementation methods described in the following illustrative embodiments do not represent all implementation methods consistent with the present disclosure. Conversely, they are only examples of the device and method that are consistent with some aspects of the present disclosure that are described in the accompanying claims.

The terms used in the present disclosure are only for the purpose of describing specific embodiments, and are not for limiting the present disclosure. The singular forms of “a,” “the,” and “said” used in the present disclosure and the accompanying claims also include plural forms, unless the context indicates other meaning expressly. It should be understood that the term “and/or” used in the present description means any or all possible combinations of one or multiple associated listed items. Unless otherwise indicated, the terms “front,” “rear,” “lower portion,” and/or “upper portion” and similar terms are only used for the convenience of description, and do not limit a position or location, or a space orientation. The terms “connect” or “connection” and other similar terms do not limit the connection to be physical or mechanical connections. The connection may also include electrical connection. The connection may be direct connection or indirect connection.

The mobile platform system of an embodiment of the present disclosure may include a mobile platform, a payload controller, a payload, and a gimbal. The payload controller may be connected to the mobile platform through a first communication link and configured to generate a payload control signal. The payload may be connected to the payload controller and configured to receive the payload control signal generated by the payload controller. The gimbal may be carried by the mobile platform. The gimbal may include a gimbal controller and a gimbal driver. The gimbal controller may be connected to the payload controller through a second communication link to control the gimbal driver. In the embodiments of the present disclosure, the payload controller may control the payload, the gimbal controller may control the gimbal driver, and the payload controller may be independent of the gimbal controller. The payload controller's control of the payload may not affect the gimbal controller's control of the gimbal driver, thereby avoiding the adverse impact on the gimbal control when controlling the payload.

The mobile platform payload system of an embodiment of the present disclosure may include a payload, a payload controller, and a gimbal. The payload controller may be connected to the payload to control the payload. The gimbal may include a gimbal controller and a gimbal driver. The gimbal controller may be connected to the payload controller to control the gimbal driver.

The mobile platform system and the mobile platform payload system of the present disclosure will be described in detail below with reference to the drawings. When there is no conflict, the embodiments and the features in the embodiments can be combined.

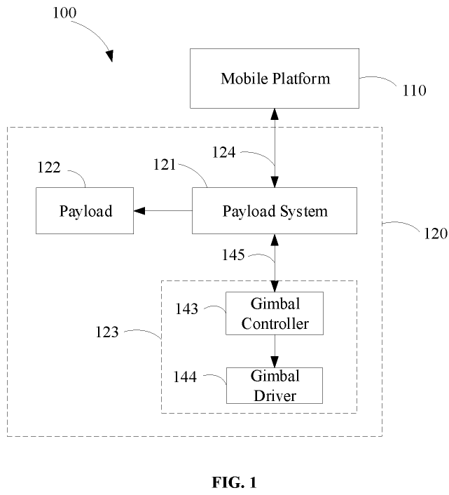

FIG. 1 is a block diagram of a mobile platform system 100 according to an embodiment of the present disclosure. The mobile platform system 100 includes a mobile platform 110 and a mobile gimbal payload system 120 (hereinafter referred to as the payload system). The mobile platform 110 may include an unmanned aerial vehicle (UAV), a robot, a mobile vehicle, a mobile boat, or an underwater mobile device. The mobile platform 110 can be controlled to move. In some embodiments, a user can send an instruction to the mobile platform 110 through a remote controller (not shown in FIG. 1), and the mobile platform 110 may move, stop, and/or perform other actions based on the instruction.

The payload system 120 includes a payload controller 121, a payload 122, and a gimbal 123. The payload controller 121 may be connected to the mobile platform 110 through a first communication link 124 for generating a payload control signal. The payload 122 may be connected to the payload controller 121 and configured to receive the payload control signal generated by the payload controller 121. The payload controller 121 may control the payload 122.

The gimbal 123 may be carried by the mobile platform 110, and the gimbal 123 may include a gimbal controller 143 and a gimbal driver 144. The gimbal controller 143 may be communicatively connected to the payload controller 121 through a second communication link 145 for controlling the gimbal driver 144. The gimbal controller 143 may be independent of the payload controller 121. The payload controller 121 may control the payload 122, the gimbal controller 143 may control the gimbal driver 144, and the control of the payload 122 by the payload controller 121 may not affect the control of the 144 by the gimbal controller 143, thereby avoiding the adverse impact on the control of the gimbal 123 when controlling the payload 122.

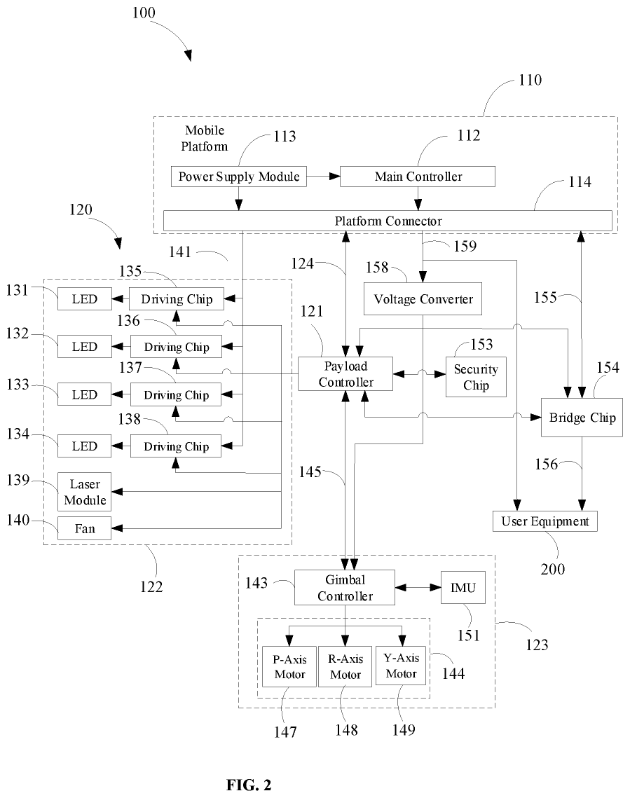

FIG. 2 is a schematic diagram of a specific implementation of the mobile platform system 100 shown in FIG. 1. The mobile platform 110 includes a main controller 112. The main controller 112 may be configured to receive instructions and control the mobile platform 110 to perform corresponding actions based on the instructions. In some embodiments, the main controller 112 may autonomously and intelligently control the mobile platform 110 to move and perform other actions. For example, the main controller 112 may control the movement of the mobile platform 110 based on a predetermined route, or plan a path in real time based on the current surrounding environment detected by a detection device (not shown in FIG. 2) to control the movement of the mobile platform 110.

The mobile platform 110 may include a power supply module 113, which can supply power to the main controller 112, and can also supply power to other components of the mobile platform 110 that require electrical energy. In the present embodiment, the power supply module 113 may supply power to the components of the payload system 120 that require electrical energy. In some embodiments, the power supply module 113 may supply a direct current of 12V, but the present disclosure is not limited thereto. In some embodiments, the power supply module 113 may supply power with other voltages based on the actual applications. In some embodiments, the power supply module 113 may include a rechargeable battery, such as a lithium battery or a hydrogen fuel cell.

The mobile platform 110 may include a platform connector 114, and the mobile platform 110 may be electrically connected to the payload system 120 through the platform connector 114. The power supply module 113 and the main controller 112 may be electrically connected to the platform connector 114. The main controller 112 may send and receive signals through the platform connector 114, and the power supply module 113 may transmit electrical energy through the platform connector 114. In some embodiments, the power supply module 113 may receive the control signal through the platform connector 114. In some embodiments, the platform connector 114 may include a quick-release connector to facilitate the insertion of the connector of the payload system 120. In some embodiments, the platform connector 114 may include a USB connector, a CAN interface, a power interface, and/or a serial port, etc. In some embodiments, the mobile platform 110 may further include a signal conditioning module, a data acquisition module, a driving module, and/or other modules not shown in FIG. 2. There modules may include hardware circuits, or a combination of hardware and software.

In some embodiments, the payload controller 121 may be connected to the platform connector 114 through the first communication link 124, and then in communication with the main controller 112. In some embodiments, the main controller 112 may send a control signal to the payload controller 121 through the first communication link 124, and the payload controller 121 may send a feedback signal to the main controller 112 through the first communication link 124. In some embodiments, the payload controller 121 may also communicate with other devices of the mobile platform 110 through the first communication link 124. The payload controller 121 may include a single chip microprocessor, a digital signal processor, or other microprocessors.

In some embodiments, the protocol of the first communication link 124 may be the same as the protocol of the mobile platform 110. The first communication link 124 can be directly connected to the communication link inside the mobile platform 110 with the same protocol as the first communication link 124 through the platform connector 114 for communication without a protocol conversion between the first communication link 124 and the corresponding internal communication link of the mobile platform 110. The first communication link 124 may be a low-speed link, including any one of a CAN link, a UART link, a PC link, a LIN link, and an SPI link, and the mobile platform 110 internal communication link may include one of the commination links mentioned above. In some embodiments, the first communication link 124 may include a CAN link, and the mobile platform 110 may also include a CAN link. In some embodiments, the first communication link 124 may include an encrypted link, which can prevent third-party devices from hacking into the mobile platform 110 through the first communication link 124 and improve the security of the system.

In some embodiments, the payload 122 may include one or more of a light emitting device, a heat dissipation device, a detection device, or an imaging device. The light emitting device can provide illumination when the mobile platform system 100 works at night or in other environment with pool lighting, and can also play a role in supplementary light during imaging. As shown in FIG. 2, the light emitting device includes LED lights 131-134, driving chips 135-138 driving the LED lights 131-134, and a laser module 139. It should be noted that FIG. 2 is for illustrative purpose only, and only shows four LED lights, but the number of LED lights is not limited thereto, as the number of LED lights can be designed based on the actual application. In other embodiments, the light emitting device may include other devices for providing illumination and/or fill light.

The heat dissipation device can dissipate heat from payloads such as the light emitting device. As shown in FIG. 2, the heat dissipation device includes a fan 140, which can dissipate heat from the LED lights 131-134, the driving chips 135-138, and the laser module 139. In other embodiments, the heat dissipation device may include semiconductor cooling fins, heat dissipation fins, or other devices capable of conducting and releasing heat. The detection device can detect the environment around the mobile platform 110, such as detecting obstacles and the like. In some embodiments, the detection device may include radar and the like. The imaging device may include a camera, a video camera, etc. In other embodiments, the payload 122 may include other devices, and the needed payloads may be connected to the payload controller 121 based on the actual application needs.

The payload controller 121 may be configured to control the light emitting device, the heat dissipation device, the detection device, and/or the imaging device. As shown in FIG. 2, the payload controller 121 controls the driving chips 135-138 to drive the LED lights 131-134 to work. In some embodiments, the payload controller 121 may output a PWM control single to the driving chips 135-138. In addition, the payload controller 121 can control the laser module 139 and the fan 140. In some embodiments, the payload controller 121 may provide a switching signal to the laser module 139 and the fan 140 to control the laser module 139 and the fan 140 to work or stop working, respectively.

The power supply module 113 of the mobile platform 110 may be electrically connected to the payload 122 for supplying power to the payload 122. The payload system 120 may include a power supply line 141, the payload 122 may be connected to the power supply line 141 and receive power through the power supply line 141. The payload 122 may be connected to the platform connector 114 through the power supply line 141, and then electrically connected to the power supply module 113. The payload 122 can be plugged into a power interface of the platform connector 114 and a hardware interface reserved by the payload controller 121, which can be quickly and easily plugged in.

The payload controller 121 may be connected to the power supply module 113 for controlling the power supply module 113 to supply power to the payload 122. The payload controller 121 may be used to generate a power supply control signal to control the power supply output to the payload 122. The power supply control signal generated by the payload controller 121 may be output to the power supply module 113 through the first communication link 124. The payload controller 121 can adjust the power supply of the power supply module 113 to the payload 122 based on a predetermined electrical parameter of the payload 122. That is, the payload controller 121 can generate the power supply control signal based on the predetermined electrical parameter of the payload 122 to adjust the electric energy received by the payload 122.

In some embodiments, the predetermined electrical parameter may include a power of the payload 122. The payload controller 121 can adjust the power provided by the power supply module 113 to the payload 122 based on the power of the payload 122, such that the power provided by the power supply module 113 can meet the demand of the high-power payloads. In some embodiments, the payload controller 121 may regulate the output voltage of the power supply module 113. In the case of loading a high-power payload 122, the output voltage of the power supply module 113 may be increased. In some embodiments, the payload controller 121 may determine a maximum voltage needed by the payload 122 based on a maximum power of the payload 122. Due to the limitation on the connectors and other devices, the flow capacity may be limited, and the current provided to the payload 122 may be limited. As such, the current output by the power supply module 113 can be fixed, such as 4 A, such that the maximum voltage can be determined. The payload controller 121 can adjust the voltage provided by the power supply module 113 to the payload 122 based on the maximum voltage value, such that the voltage output by the power supply module 113 can reach the maximum voltage value, thereby satisfying the electrical energy demand of the payload 122.

In some embodiments, the second communication link 145 may include an encrypted link, which can prevent third-party devices from hacking into the mobile platform system 100 through the second communication link 145 and improve the security of the system. In some embodiments, the second communication link 145 may include any one of a CAN link, a UART link, a PC link, a LIN link, and an SPI link. In some embodiments, the payload controller 121 may convert the communication protocol between the second communication link 145 and the first communication link 124, and communicatively connect the gimbal controller 143 to the mobile platform 110. The payload controller 121 can convert the protocol of the first communication link 124 to the protocol of the second communication link 145. For example, the payload controller 121 can convert any one of the communication protocols of the CAN link, UART link, PC link, LIN link, and SPI link to the communication protocol of another link. The protocol of the first communication link 124 may be consistent with the internal protocol of the mobile platform 110, such that the payload controller 121 may convert the internal protocol of the mobile platform 110 into an external protocol. Therefore, it is not necessary to know the internal commination mechanism of the mobile platform 110 when developing the gimbal controller 143, as the development of the gimbal controller 143 can be based on the commination mechanism between gimbal controller 143 and the payload controller 121, thereby simplifying the development of the gimbal controller 143.

The gimbal driver 144 may include a three-axis motor for driving a gimbal support mechanism (not shown in FIG. 2) to rotate. The gimbal support mechanism may be connected to the mobile platform and may support the imaging device, etc. The three-axis motor may include a P-axis motor 147, an R-axis motor 148, and a Y-axis motor 149, which respectively drive the rotation of the gimbal support mechanism in different directions. The gimbal controller 143 may control the rotation angle and/or rotation speed of the rotation axis of the P-axis motor 147, the R-axis motor 148, and the Y-axis motor 149, respectively. As such, during the imaging process, the gimbal support mechanism can drive the imaging device to turn to different directions.

In some embodiments, the payload 122 may be carried by the gimbal 123. The LED lights 131-133, the laser module 139, and the fan 140 in FIG. 2 may be mounted on the gimbal 123, and can be carried by the support mechanism of the gimbal 123. In some embodiments, the movement of the gimbal support mechanism may drive the payload 122 to move. The gimbal controller 143 and the gimbal driver 144 can be mounted on the gimbal support mechanism.

In some embodiments, the gimbal controller 143 may be in communication with an inertial measurement unit (IMU) 151, which can be used to measure the three-axis attitude angle (or angular rate) and the acceleration of the gimbal support mechanism. The IMU 151 may be configured to provide measured information to the gimbal controller 143, and the gimbal controller 143 may control the gimbal driver 144 based on the information. In some embodiments, the gimbal controller 143 may control the operation of the IMU 151. The IMU 151 may be mounted on the gimbal support mechanism.

In some embodiments, the payload controller 121 may also be electrically connected with a security chip 153. The payload controller 121 may control the payload 122 after the security chip 153 is unlocked. In this way, the working state of the payload 122 may be controlled by the security chip 153, thereby serving the purpose of security. If the security chip 153 is locked or disconnected, the payload controller 121 may control the payload 122 not to work. For example, when the payload 122 includes a laser module 139 that is harmful to human eyes, the payload controller 121 may control the laser module 139 not to work when the security chip 153 is locked or disconnected. After the security chip 153 is unlocked, the payload controller 121 may control the laser module 139 to work, which can serving the purpose of security. In some embodiments, the payload controller 121 may instruct the gimbal controller 143 to start controlling the gimbal driver 144 after the security chip 153 is unlocked.

As shown in FIG. 2, the payload controller 121 is also be electrically connected to a bridge chip 154 that is connected to the mobile platform 110 through a third communication link 155, and is connected to a fourth communication link 156 for connecting a user equipment 200. The bridge chip 154 may be used to perform communication protocol conversion between the fourth communication link 156 and the third communication link 155. The third communication link 155 may be connected to the platform connector 114, and the protocol of the third communication link 155 may be the same as the protocol of the mobile platform 110. In some embodiments, the third communication link 155 may be a high-speed link, which may include any one of a USB link, an ETH link, a MIPI link, an LVDS link, and an LVCMOS link. The mobile platform 110 may include one of the communication links mentioned above, such that the third communication link 155 may communicate directly with the same communication link in the mobile platform 110. In some embodiments, the third communication link 155 may include a USB link, and the mobile platform 110 may include a USB link.

In some embodiments, the fourth communication link 156 may be connected to the user equipment 200, and the user equipment 200 may be electrically connected to the mobile platform 110 through the fourth communication link 156, the bridge chip 154, and the third communication link 155. The user equipment 200 may include an imaging device, such as a video camera or a camera, a mobile phone, a computer, and/or other electronic equipment. In some embodiments, the fourth communication link 156 may be a high-speed link, which may include any one of a USB link, an ETH link, a MIPI link, an LVDS link, and an LVCMOS link. In some embodiments, the fourth communication link 156 may include Ethernet. The bridge chip 154 may convert the protocol of the third communication link 155 to the protocol of the fourth communication link 156. For example, the bridge chip 154 may convert the USB communication protocol to Ethernet communication protocol. The protocol of the third communication link 155 may be consistent with the internal protocol of the mobile platform 110. In this way, the bridge chip 154 may convert the internal protocol of the mobile platform 110 into an external protocol. Therefore, when the user may develop the user equipment 200 based on the communication mechanism between the user equipment 200 and the bridge chip 154, without knowing the internal commination mechanism of the mobile platform 110, thereby simplifying the development of the user equipment 200.

In some embodiments, images may be transmitted between the user equipment 200 and the mobile platform 110 through the third communication link 155, the bridge chip 154, and the fourth communication link 156, but is not limited thereto. In other embodiments, other signals may be transmitted between the user equipment 200 and the mobile platform 110. In some embodiments, the transmission speed of the third communication link 155, the bridge chip 154, and the fourth communication link 156 may be faster than the second communication link 145, the payload controller 121, and the first communication link 124, and may be used as a high-speed transmission channel.

The payload controller 121 can control the bridge chip 154. In some embodiments, the payload controller 121 may be used to control the bridge chip 154 after the security chip 153 is unlocked. When the security chip 153 is locked or disconnected, the payload controller 121 may block the control of the bridge chip 154, such that the bridge chip 154 may not perform protocol conversion on the third communication link 155 and the fourth communication link 156, and the user equipment 200 may not communicate with the mobile platform 110.

As shown in FIG. 2, the power supply module 113 of the mobile platform 110 supplies power to the user equipment 200 through the platform connector 114. In some embodiments, when the security chip 153 is locked or disconnected, the payload controller 121 may control the power supply module 113 to stop the power supply through the first communication link 124, thereby stopping the power supply to the user equipment 200. As such, the user equipment 200 cannot connect to the mobile platform 110 through the payload system 120 and cannot realize any function. After the user equipment 200 obtains the permission of the security chip 153, the security chip 153 can be unlocked, the payload controller 121 can control the bridge chip 154 to work normally, and control the power supply module 113 to supply power to the user equipment 200, such that the user equipment 200 can be used normally.

In some embodiments, the bridge chip 154 may block the communication between the fourth communication link 156 and the third communication link 155 in response to detecting the current transmitted by the fourth communication link 156. When the user equipment 200 is abnormal, the user equipment 200 may supply current to the bridge chip 154 through fourth communication link 156. The bridge chip 154 may actively shut down in response to detecting the current to prevent the current from destroying the third communication link 155 and the mobile platform 110, thereby protecting the payload system 120 and the mobile platform 110 during communication.

In some embodiments, when an amount of data on the third communication link 155 exceeds a threshold, the bridge chip 154 may send a signal indicating link congestion through the fourth communication link 156. The threshold may be set based on the bandwidth of the third communication link 155. The bridge chip 154 may communicate with the user equipment 200 when the amount of data on the link of the bridge chip 154 is too large and causing congestion, and the bridge chip 154 may send a signal requesting the user equipment 200 to stop sending data, etc., thereby preventing congestion of the third communication link 155 and the link within the mobile platform 110, and achieving communication protection.

In some embodiments, the mobile platform system 100 may include a voltage converter 158. The voltage converter 158 may be electrically connected to the power supply module 113, the payload controller 121, and the gimbal controller 143. The voltage converter 158 may be used to convert the voltage output by the power supply module 113 and provide the converted voltage output to the payload controller 121 and the gimbal controller 143. The voltage converter 158 may be connected to a power supply line 159 of the payload system 120, and electrically connected to the power supply module 113 through the power supply line 159 and the platform connector 114. In some embodiments, the voltage converter 158 may include a DC voltage converter. The voltage converter 158 may convert a 12V voltage to a 3.3V voltage and provide it to the payload controller 121 and the gimbal controller 143. As shown in FIG. 2, the voltage converted by the voltage converter 158 is also supplied to the bridge chip 154.

In some embodiments, the payload controller 121, the first communication link 124, and the second communication link 145 may be packaged in an adapter (not shown in FIG. 2). A communication interface (e.g., a CAN port) may be disposed on the adapter. The communication interface may be connected to the first communication link 124, and plugged into the platform connector 114 of the mobile platform 110. A communication interface to connect to the second communication link 145 may also be disposed on the adapter and the adapter may be plugged into the connector of the gimbal 123. A control interface may be disposed on the adapter to connect to the payload controller 121 and the payload 122, and the connector of the payload 122 may be plugged into the control interface.

In some embodiments, the 153 may be packaged in an adapter. In some embodiments, the bridge chip 154 may be packaged in an adapter including a communication interface (e.g., a USB interface) to connect to the third communication link 155, and the adapted may be plugged into the platform connector 114. The adapter may further include a communication interface (e.g., a network port) connected to the fourth communication link 156, and the adapter may be plugged into the communication interface of the user equipment 200. In some embodiments, the voltage converter 158 may be packaged in an adapter. A power input interface may be disposed on the adapter, and the adapter may be plugged into the power interface of the platform connector 114. The adapter may further include a power output interface, which may be plugged into the power interface of the gimbal 123 to supply power to the gimbal controller 143. The payload 122, the gimbal 123, and/or the user equipment 200 may be plugged into the adapter, and the electrical connection with the mobile platform 110 may be realized through the adapter. In some embodiments, the payload 122 and the adapter may be integrated to form an integral quick-release device, and then assembled on the mobile platform 110 to achieve quick-release with the mobile platform 110.

FIG. 2 is merely an exemplary embodiment, and the present disclosure is not limited to the embodiment shown in FIG. 2. In some embodiments, the mobile platform system 100 may further include other components not shown in FIG. 2.

It should be noted that in this specification, the relational terms such as “first,” “second” etc., are only used to distinguish one entity or operation from another entity or operation, and do not require or imply that any such actual relationship or order exists between these entities or operations. The term “including,” “comprising” or any of their variations encompass non-exclusive inclusion, such that the process, method, object or device that includes a series of elements not only include those elements, but also include other elements that have not been expressly listed, or also include inherent elements included in the process, method, object or device. When not limited further, an element modified by the phrase “including a . . .” does not exclude that the process, method, object or device that includes the element also includes other same elements.

The above introduced in detail the method and device provided by the embodiments of the present disclosure. This specification uses specific examples to explain the principle and implementation methods of the present disclosure. The descriptions of the above embodiments are only used to help understand the methods and core spirit of the present disclosure. In the meantime, a person having ordinary skills in the art can have modifications to the specific implementation methods and application scope based on the spirit of the present disclosure. In summary, the content of the present specification should not be understood to limit the present disclosure.

What is claimed is:

1. A mobile platform system, comprising:
a mobile platform;
a payload controller connected to the mobile platform through a first communication link for generating a payload control signal;
a payload connected to the payload controller and configured to receive the payload control signal; and
a gimbal carried by the mobile platform, the gimbal including a gimbal controller and a gimbal driver, the gimbal controller being communicatively connected to the payload controller through a second communication link to control the gimbal driver.

2. The mobile platform system of claim 1, wherein:
the payload is being carried by the gimbal.

3. The mobile platform system of claim 1, wherein:
the mobile platform includes a power supply module, and the power supply module is electrically connected to the payload and used to supply power to the payload.

4. The mobile platform system of claim 3, wherein:
the payload controller is connected to the power supply module for controlling the power supply module to supply power to the payload.

5. The mobile platform system of claim 4, wherein:
the payload controller is configured to adjust the power supply of the power supply module to the payload based on an electrical parameter of the payload.

6. The mobile platform system of claim 3, further comprising:
a voltage converter electrically connected to the power supply module, the payload controller, and the gimbal controller, and the voltage converter being configured to convert a voltage output by the power supply module and provide the converted voltage to the payload controller and the gimbal controller.

7. The mobile platform system of claim 1, wherein:
the payload controller is configured to convert a communication protocol between the second communication link and the first communication link, and communicatively connect the gimbal controller to the mobile platform.

8. The mobile platform system of claim 1, wherein:
the first communication link includes a first encrypted link.

9. The mobile platform system of claim 1, wherein:
the second communication link includes a second encrypted link.

10. The mobile platform system of claim 1, wherein:
the protocol of the first communication link is the same as the protocol of the mobile platform.

11. The mobile platform system of claim 1, wherein:
a security chip is electrically connected to the payload controller, and the payload controller controls the payload after the security chip is unlocked.

12. The mobile platform system of claim 1, wherein:
a bridge chip is electrically connected to the payload controller, the bridge chip being connected to the mobile platform through a third communication link, the bridge chip being connected to a fourth communication link for connecting to a user equipment; and the bridge chip is used to convert a communication protocol between the fourth communication link and the third communication link.

13. The mobile platform system of claim 12, wherein:
a security chip is electrically connected to the payload controller, and the payload controller is used to control the bridge chip after the security chip is unlocked.

14. The mobile platform system of claim 12, wherein:
the bridge chip is configured to block the communication between the fourth communication link and the third communication link in response to detect a current transmitted through the fourth communication link.

15. The mobile platform system of claim 12, wherein:
the bridge chip is configured to send a signal indicating link congestion through the fourth communication link in response to an amount of data on the third communication link exceeding a threshold.

16. The mobile platform system of claim 1, wherein:
the payload includes one or more of a light emitting device, a heat dissipation device, a detection device, and an imaging device.

17. A mobile platform payload system, comprising:
a payload;
a payload controller connected to the payload for controlling the payload; and
a gimbal including a gimbal controller and a gimbal driver, the gimbal controller being communicatively connected to the payload controller for controlling the gimbal driver.

18. The mobile platform payload system of claim 17, wherein:
the payload is being carried by the gimbal.

19. The mobile platform payload system of claim 17, further comprising:
a power supply line, the payload being connected to the power supply line to receive power through the power supply line.

20. The mobile platform payload system of claim 19, wherein:
the payload controller is used to generate a power supply signal to control a power supply output of the payload.
